(19) United States
(12) Patent Application Publication
(10) Pub. No.: US 2011/0055910 A1
(43) Pub. Date: Mar. 3, 2011

(54) USER-CENTRIC INTERCEPTION

(76) Inventors: Francesco Attanasio, Nocera Superiore (IT); Raffaele De Santis, Mercato San Severino (IT)

(21) Appl. No.: 12/665,721

(22) PCT Filed: Jun. 6, 2007
(86) PCT No.: PCT/SE2007/000662

§ 371 Date: Nov. 14, 2010

(51) Int. Cl. H04L 9/32; G06F 15/173

(52) U.S. Cl. 726/6; 709/224

(57) ABSTRACT

The present invention relates to methods and arrangement for user-centric interception in a telecommunication system wherein correlated identities are federated in an Identity Management Controller. The method comprises: Sending from an Intercept Unit to the Identity Management Controller, a request for identities correlated with a specified key target identity. The Intercept Unit receives identities federated to the specified key target identity. The received identities are utilized for user-centric interception purposes.

### TECHNICAL FIELD

The present invention relates to methods and arrangements to provide user-centric interception of communications in a network.

### BACKGROUND

Lawful Intercept is the process of legally monitoring voice and data communications between parties of interest to law enforcement agencies.

FIG. 1 belongs to prior art and discloses an Intercept Mediation and Deliver Unit IMDU, also called Intercept Unit, that is a solution for monitoring of Interception Related Information IRI and Content of Communication CC for the same target. The different parts used for interception are disclosed in current Lawful Interception standards (see 3GPP TS 33.108 and 3GPP TS 33.107—Release 7). A Law Enforcement Monitoring Facility LEMF is connected to three Mediation Functions respectively for ADMF, DF2, DF3 i.e. an Administration Function ADMF and two Delivery Functions DF2 and DF3. The Administration Function and the Delivery Functions are each one connected to the LEMF via standardized handover interfaces HI1-HI3, and connected via interfaces X1-X3 to an Intercepting Control Element ICE in a telecommunication system. Together with the delivery functions, the ADMF is used to hide from ICEs that there might be multiple activations by different Law Enforcement Agencies. Messages REQ sent from LEMF to ADMF via HI1 and from the ADMF to the network via the X1 interface comprise identities of a target that is requested to be monitored. The Delivery Function DF2 receives Intercept Related Information IRI from the network via the X2 interface. DF2 is used to distribute the IRI to relevant Law Enforcement Agencies via the HI2 interface. The Delivery Function DF3 receives Content of Communication CC, i.e. speech and data, on X3 from the ICE. Requests are also sent from the ADMF to a Mediation Function MF3 in the DF3 on an interface X1_{—}3. The requests sent on X1_{—}3 are used for activation of Content of Communication, and to specify detailed handling options for intercepted CC. In Circuit Switching, DF3 is responsible for call control signaling and bearer transport for an intercepted product. Intercept Related Information IRI, received by DF2 is triggered by Events that in Circuit Switching domain are either call related or non-call related. In Packet Switching domain the events are session related or session unrelated. Keeping focus on the scope of this proposal, impacted areas are administration, delivery functions and HI interfaces. For interception, there needs to be a means of identifying the target, correspondent and initiator of the communication. Target Identities used for interception of CS and GPRS service are MSISDN, IMEI and IMSI.

Historically each application environment handles its own user identity information and performs the access control functions associated with it. In the telecom world, the fact of having to administer the same user for all access networks, terminals, and applications/services leads to a centralized user information management system serving all of them. At the current stage, there is a shift from “vertical” type of service platforms, that is, designed for specific vertical services or service types (Location Based Services, Multimedia Messaging, Streaming, . . . etc) towards horizontal type of platforms (that is, for all services and accesses and terminals). In this evolving scenario, an important role of the telecom operator is relating to the Identity Management. Identity Management consists of the handling of identity information in combination with access control of users to various services. Identity information in this respect is all information about an entity, individual or service provider (User-ID, social security number, address, etc.) which in some way can be associated to the entity and in some way utilized to adapt the available information to the user. As service networks expand in importance, both internally within the realm of the operator but also provided by independent Service Providers, Identity Management from a service point of view will expand in importance. Identity Management is evolving to be a function that straddles the borderline between the core network and the service layer.

The Ericsson Identity Management EIM solution, described in EIM 1.0 Ericsson Product Catalogue is the user identity platform for service delivery that enables new business roles for the operators. It provides operators with standardized mechanisms to federate identity according to OASIS SAML 2.0 protocols and procedures. The solution supports internal as well as external federation of identity, session and service profile management and is built on well established Ericsson products in combination with system integration services. Ericsson Identity Controller EIC 1.0 is described in the technical product description 221 02-FGC 101 472. EIC 1.0 is the product in EIM 1.0 solution that implements the Identity Provider functionality, as described in OASIS SAML v2.0, and so provides the ability to federate user identities internally between the user databases of different divisions of the operator as well as external content and service providers for the exchange of identity information. EIC 1.0 supports the following main functions:

A. Identity Management. EIC provides a central point of management of the user information and identity is one of the most valuable information regarding users. The Identity Management function in EIC provides mechanisms for generating user aliases (increasing the security level) storing and mapping between different user identities, both permanent and temporal. Central management of the user identities allows the operator to easily control the privacy of the users when interacting with 3rd parties by the usage of meaningless aliases. Among the user identities in EIC there are username, MSISDN, IP address and identifiers for accessing services. The solution can be configured to expose only a certain set of user context data to applications, avoiding them the publication of sensitive user context information.
B. Single Sign On (SSO). Three SSO features are supported: Walled-garden (SSO experience and authentication enabling services to operator internal applications); Federated (enabling services to external applications through the standard mechanism defined by Liberty Alliance). Finally, a SAML-based SSO function is also supported for providing an open, secure and standards SSO solution with decentralized authentication according to SAML v2.0 specifications. SAML supports several user identifier formats, for example, MSISDN, e-mail address, persistent identifiers or transient identifiers.
C. Attribute Sharing. EIM solution also exposes user dynamic data to trusted applications. Through this capability, an application gets momentum knowledge of an end-user established session information for usage by advanced data service offerings. As example, an application can use such information to send an email or video stream to a device knowing that the user is GPRS active and can enjoy the offered service instantly.

When a Trusted Application wants to personalize its offered services, it requires knowing who the end-user is. But in most of the occasions, an Application only knows the IP address of an end-user accessing to its services. So it requires then some mechanism in order to translate the end-user IP address into an end-user identifier (MSISDN, username, NAI, application specific user alias, etc.).

### SUMMARY

The present invention relates to problems how to provide user-centric Lawful Interception in a communication network. In the current Lawful Interception LI standard solution, when intercepting per single target identities (possibly multiple identities and specific per each service) it is not always possible to have a complete user interception. In fact, relevant traffic information could be lost since the same target could use different identities (not all a priori known to the Law Enforcement Agency) to communicate, and a lawful agency could get the knowledge of only a slice of relevant info. A further problem arises if the target subscribes to new services (so getting new digital identities), other info can be lost for LI purposes since the agency is not informed at all or in time.

The solution to the problems is to introduce an enhancement of the LI solution for a user-centric interception that, on the basis of only one of the known identities of the target user, enables the interception of all current and future network and service activities of the target. This is pursued by imposing to the Operator the usage of an enhanced LI-Management System that inter-works with an Identity Management solution for using it as LI supporting function.

The solution to the problems more in detail comprises a method for user-centric interception in a telecommunication system whereby correlated identities are federated in an Identity Management Controller, comprising the following steps:
A request for identities correlated to a specified key target identity is sent from an Intercept Unit to the Identity Management Controller.
The identities federated to the specified key target identity are received to the Intercept Unit.
The received identities are utilized for user-centric interception purposes.

The further mentioned problem, i.e. if the target subscribes to new services not known to the agency, is solved by the invention by requesting new identities if a new subscription for the specified target identity is recognized by the Management Controller. The method hereby comprises the following further steps:
Requesting new identities for new subscriptions for the specified target when recognized by the Identity Management Controller.
A new subscription for the specified target identity is detected in the Identity Management Controller.
A new identity related to the new subscription is received from the Identity Management Controller to the Intercept Unit.

An object of the invention is to enable interception of all current and future network and service activities of a defined target. This object and others are achieved by methods, arrangements, nodes, systems and articles for manufactures.

### ADVANTAGES OF THE INVENTION ARE AS FOLLOWS

### For Operators

Identity Management feature in conjunction with the LI functionality could provide new revenue opportunities (e.g., added value offer to LEA as a solution for detection of user identities and automatic target interception.
In the emerging multi-service network scenarios, the “subscriber information” is becoming a valuable asset of the Operator and can be used for LEA convenience in LI investigation purposes.
Re-use also for LI purposes of Identity Management systems and more in general of other User Management facilities that the Operator normally uses for the network/service operations.

For Agencies
Immediate knowledge of new services subscription or new identities associated with a monitored object
The invention introduces a generic mechanism to detect user identities, which are required to activate the LI interception, covering any type of network services and any type of user identities, in a network scenario of continuously increasing number of provided telecommunication services.
The mechanism gives the Agency the possibility to automatically intercept on subject basis, without the need to manually and continuously set the interception on the several target identities (that the subject could own in a multi-service network).

The invention will now be described more in detail with the aid of preferred embodiments in connection with the enclosed drawings.

### BRIEF DESCRIPTION OF THE DRAWINGS

FIG. 1 is part of the prior art and discloses a block schematic illustration of an Intercept Mediation and Delivery Unit attached to an Intercepting Control Element.

FIG. 2 is a in a block schematic illustration disclosing an Intercept Mediation and Delivery Unit attached to an Identity Management Controller system and to Intercepting Control Elements.

FIG. 3 discloses a signal sequence diagram representing a method for querying known and new target Ids in order to utilize received Ids for monitoring purposes.

FIG. 4 discloses a signal sequence diagram representing a method for agency querying of known and new target Ids.

FIG. 5 discloses a flow chart illustrating some essential method steps of the invention.

FIG. 6 discloses a block schematic illustration of a system that can be used to put the invention into practice.

### DETAILED DESCRIPTION

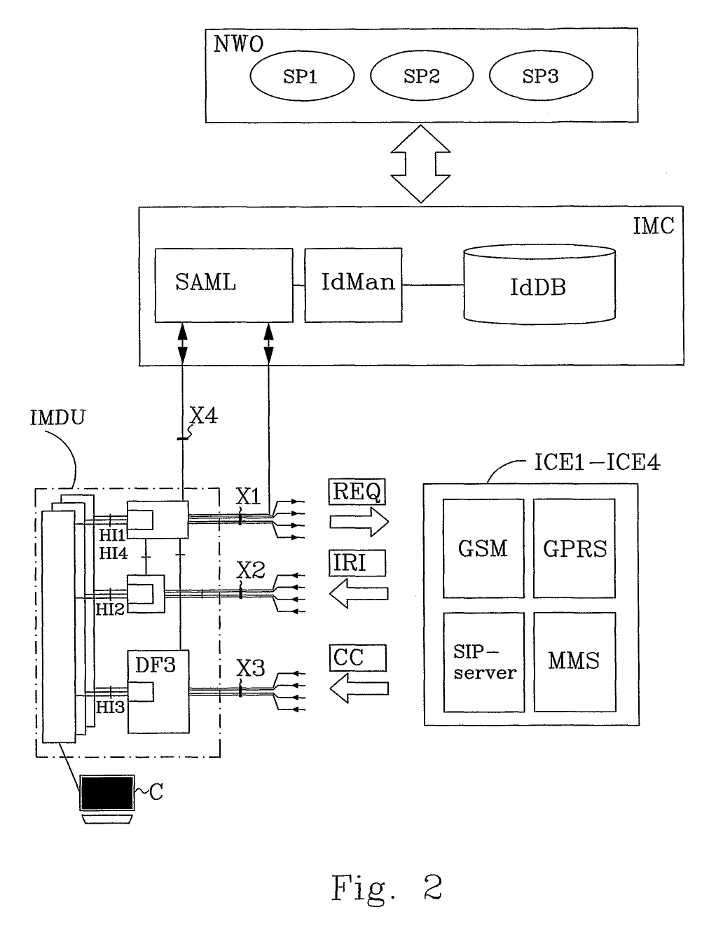

An Intercept Mediation and Deliver Unit IMDU is schematically disclosed in FIG. 2. The Intercept Unit IMDU has already been explained in background part of this patent application. The IMDU is attached to an Identity Management Controller System IMC. The function of the IMC is the same as the Ericsson Identity Management mentioned in the background part of this application, but can of course be of another brand. The IMC provides a central point of management of user information, and identity is one of the most valuable information regarding users. The IMC comprises a Security Assertion Markup Language interface SAML for accessing application services. An Identity Management function IdMan attached to the SAML provides mechanisms for generating user aliases storing and mapping between different user identities such as MSISDN, IP address both permanent and temporal. The IdMan is attached to an Identities DataBase IdDB. The IdDB is a centrally located database that upon request from an application server, such as a service provider, stores and maps user identities. The IMC implements the Identity Provider functionality, as described in the standard OASIS SAML v2.0, and so provides the ability to federate user identities internally between the user databases of different divisions of an operator as well as external content and service providers for the exchange of identity information. Three different accessible service nodes so called Service Providers SP1, SP2, and SP3 of a NetWork Operator NWO are schematically shown in FIG. 2. SP1 represents a GSM/GPRS service (Global System for Mobile communications/General Packet Radio Service), SP2 represents an IMS service (IP Multimedia Subsystem) and SP3 represents an MMS service (Multimedia Messaging Services). FIG. 2 further discloses four different ICEs. ICE1 is a GSM node, ICE2 is a GPRS node, ICE3 is SIP server and ICE4 is an MMS node. The Administration Function ADMF in the IMDU is attached to each one of the four ICEs via the interface X1. Messages REQ sent from LEMF to ADMF via HI1 and from the ADMF to the ICEs via the X1 interface comprise identities of a target that is to be monitored. The delivery function DF2 is attached to each one of the four ICEs. The Delivery Function DF2 receives Intercept Related Information IRI from the ICEs via the X2 interface. DF2 is used to distribute the IRI to relevant Law Enforcement Agencies via the HI2 interface. The Delivery Function DF3 is attached to each one of the four ICEs. The Delivery Function DF3 receives Content of Communication CC, i.e. speech and data, on the X3 interface from the ICEs.

The interface X1 is furthermore located between the ADMF and the Identity Management Controller IMC. X1 is used to request user-centric identities from the IMC. The IMDU hereby accesses the SAML via the X1 interface and requests user-centric identities stored in the IdDB.

An interface HI4/X4 is according to the invention disclosed in FIG. 2 between the LEMF and the IMC, via the ADMF. While X1 is used to request current identities in IMC as well as to set in IMC the monitoring of any new subscription (that will be notified on X2 as IR1 to MF2), X4 is a 2-way command interface, used to receive also spontaneous notifications about new subscriptions of a given subscriber. The interface HI/X4 is intended for requests, and responses that not immediately will be used for interception purposes but instead will be sent to an Agency for mediate treatment. The IMDU accesses the SAML via the X4 interface and requests user-centric identities stored in the IdDB. A computer C is attached to the LEMF and used by the agency. The interface HI4/X4 and the computer C will be further discussed in a second embodiment of the invention, and described later in this patent application.

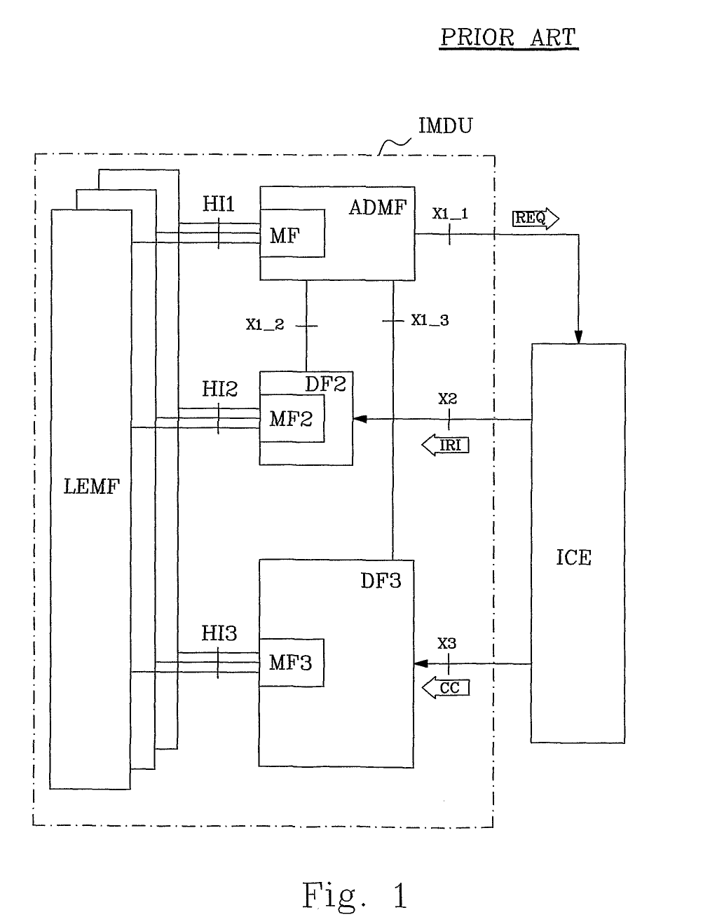

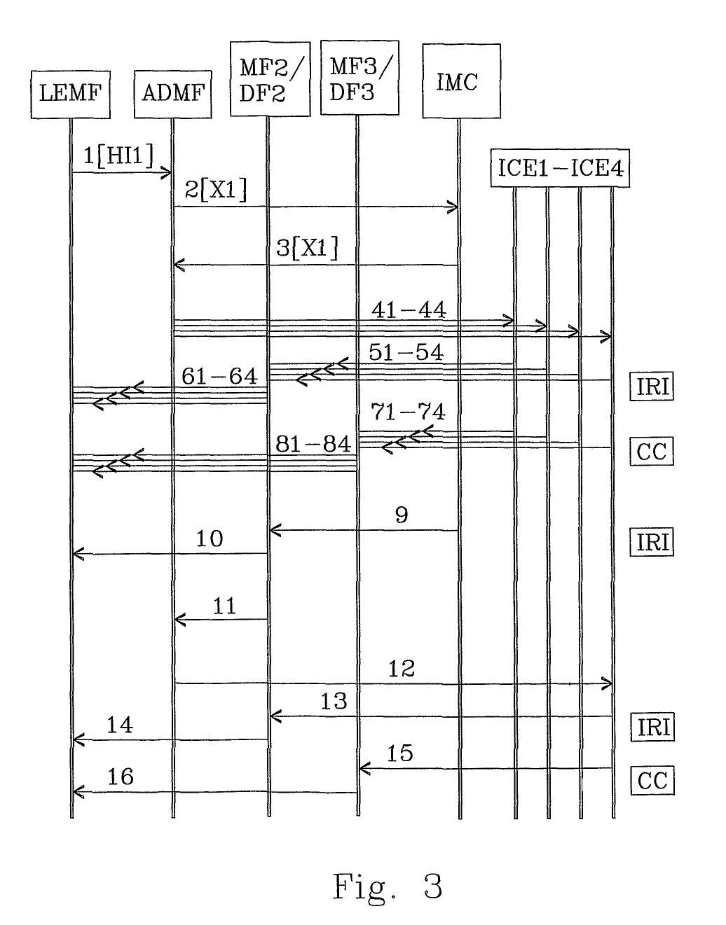

A first embodiment of the invention is disclosed in FIG. 3. FIG. 3 is to be read together with FIGS. 1 and 2. FIG. 3 shows a method when identities federated to a target subscriber T are requested by the IMDU to be received from the IMC and used for monitoring purposes. A prerequisite for the invention is that all identities federated with for example a MSISDN number currently subscribed by the target T are stored in the Identity database IdDB in the IMC. Subscriptions/Identities are collected by IMC at the provisioning phase of the service nodes. The collecting and storing of identities by the IMC have been described in the background part of this application and is well known by those of skill in the art.

The method according the first embodiment comprises the following steps:
A request 1 for user-centric interception is sent from the Law Enforcement Monitoring Facility LEMF to the Administration Function ADMF on the interface HI1. The LEMF requires the user-centric interception by sending a known target identity, in this example MSISDN, as key to find federated identities related to the target. It is requested in 1 to intercept the target T for all the current and future known identities.
The request is forwarded 2 from the ADMF to the Identity Management Controller IMC on the interface X1. The request is hereby sent to the Security Assertion Markup Language Interface SAML in the IMC (see FIG. 2). The Identity Management function IdMan attached to the SAML generates user aliases storing and mapping between different user identities. The IdMan is attached to the Identities DataBase IdDB wherein the identities related to the target key MSISDN have been be stored.
Identities related to the target T have been received by IdMan from the Network Operator NWO and stored in the IdDB. In this example the following identities related to the targets MSISDN number have been collected and stored in the IdDB:
   IMSI. The International Mobile Subscriber Identity IMSI is a unique identifier allocated to each mobile subscriber in a GSM and UMTS network. In this example the IMSI is the identity used by the target T for a GSM/GPRS service. IMSI is collected from SP1.
   SIP_URI. Identifies the home network domain used to address the Session Initiated Protocol request. The SIP-URI is the identity used by the target for an IMS service. SIP_URI is collected from SP2.
   MSISDN@mms_NWO_domain. Represents the identity of the target when a Multimedia Messaging Service is used. MSISDN@mms_NWO_domain is collected from SP3.
The identities federated to MSISDN, found in the IdDB, are sent 3 from IdDB via SAML in IMC on the X1 interface to the ADMF (see also FIG. 2).
A request for interception 41-44 is sent from ADMF to each one of the ICE's. Each request comprises an identity related to the target and is sent to the concerned ICE according to the following signal sequence scheme:
   An activation of interception related to the target T when using the identity MSISDN is sent to the GSM node.
   An activation of interception related to the target when using the identity IMSI is sent to the GPRS node.
   An activation of interception related to the target when using the identity SIP_URI is sent to the SIP server.
   An activation of interception related to the target when using the identity MSISDN@mms_NWO_domain is sent to the MMS node.
In this example, activations from the targets are detected in all ICEs. Examples of activations can be user entrance or service usage etc.
Intercept Related Information IRI is sent 51-54 from the ICEs, i.e. from the GSM node, the GPRS node, the SIP server and from the MMS node, to MF2/DF2 and forwarded 61-64 from MF2/DF2 to the LEMF.
Content of Communication CC is sent 71-74 from the ICEs, i.e. from the GSM node, the GPRS node, the SIP server and from the MMS node, to MF3/DF3 and forwarded 81-84 from MF3/DF3 to the LEMF.

Since it was requested in 1 to intercept the target subject not only for all the current identities but also for future known identities, the method comprises the following further steps:
A new service subscription related to the target T is detected by the MMS node. The new service is an MMS service subscribed with the identity nickname@mms_NWO_domain. When the new MMS subscription is provisioned to SP3, the IMC will be informed of that. The identity nickname@mms_NWO_domain related to the target MSISDN is received by IdMan from SP3 in the NetWork Operator NWO and stored in the IdDB.
A notification comprising the new identity nickname@mms_NWO_domain federated to MSISDN is sent 9 from IMC to MF2/DF2. LEMF is notified 10 of the new subscription.
The new identity is sent 11 from MF2/DF2, to the ADMF.
An activation of interception related to the target when using the new identity nickname@mms_NWO_domain is sent 12 from ADMF to the MMS node (ICE4).
A target activation is detected in the MMS node. The detected activity refers to the new identity (nickname@mms_domain), e.g. the target T is sending a MMS from the web access to the MMS server (such activity would have been not detected by means of the other identity MSISDN@mms_domain).
Intercept Related Information IRI is sent 13 from the MMS node (ICE4) to MF2/DF2 and forwarded 14 from MF2/DF2 to the LEMF.
Content of Communication CC is sent 15 from the MMS node (ICE4), to MF3/DF3 and forwarded 16 from MF3/DF3 to the LEMF.

To be observed is that the request for future known identities is optional and not a prerequisite for the invention.

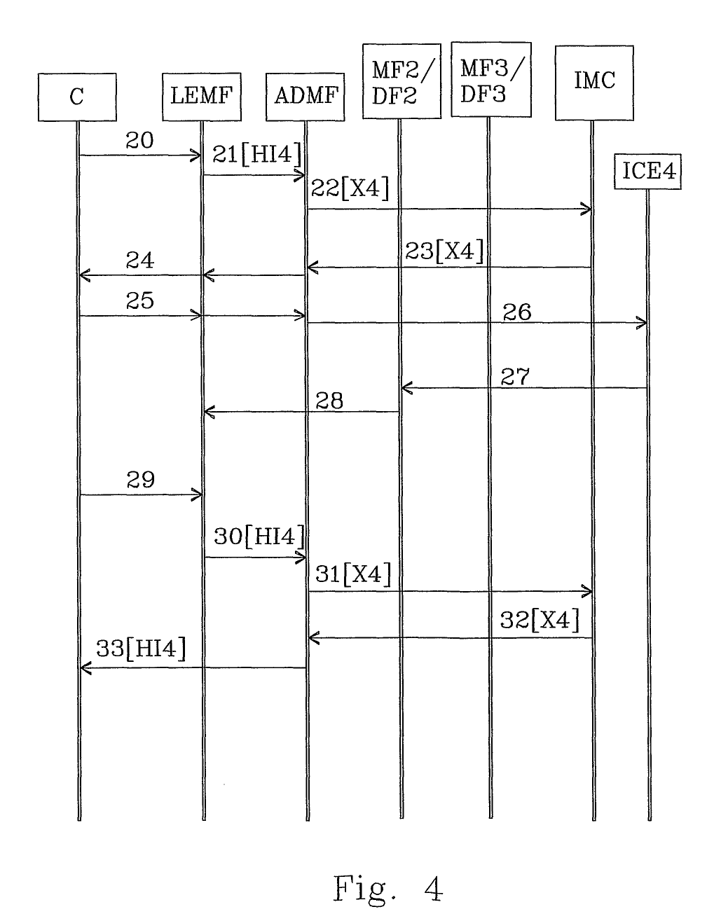

A second embodiment of the invention is disclosed in FIG. 4. FIG. 4 is to be read together with FIGS. 1 and 2. FIG. 4 shows a method when identities federated to the target subscriber T are requested for mediate treatment by an agency using the computer C. In the second embodiment the agency requests user-centric identities for analysis and possibly further interception. Like before, a prerequisite for the invention is that all identities, federated with for example a MSISDN number currently subscribed by the target T, are stored in the Identity database IdDB in the IMC. The second embodiment is in many parts similar to the first embodiment and the same target T and a subset of the same identities as was used in the first embodiment will be used in the second embodiment. In the second embodiment the X4 interface is used between the ADMF and the SAML and the HI4 interface is used between the LEMF and the ADMF.

The method according the second embodiment comprises the following steps:
A demand 20 for user-centric identities related to the target T is sent by the Agency from the computer C to the Law Enforcement Monitoring Facility LEMF.
A request 21 for user-centric identities is sent from the Law Enforcement Monitoring Facility LEMF to the Administration Function ADMF on the interface HI4. The LEMF requires the user-centric identities by sending the known target identity MSISDN as key to find federated identities related to the target. The LEMF requests to be informed about all the identities currently known of the target T.
The request is forwarded 22 from the ADMF to the Identity Management Controller IMC on the interface X4.
In this example the identity MSISDN@mms_NWO_domain has been stored in the IdDB among the other identities relating to the services currently subscribed by the target T.
The currently known identities are sent 23 from IMC on the X4 interface to the ADMF.
The known identities are forwarded 24 from the ADMF via LEMF to the computer C where they can be seen by the agency.
The agency decides to intercept the target when using the MMS service;
A request for interception of the target using the identity MSISDN@mms_NWO_domain is demanded by the agency and sent 25 from C to ADMF via LEMF.
The request for interception is forwarded 26 from ADMF to the MMS node, i.e. to ICE4. An activation of interception related to the target when using the identity MSISDN@mms_NWO_domain is hereby sent to and detected by the MMS node.
Target activation, such as service usage, is detected in the ICE4.
Intercept Related Information IRI is sent 27 from the MMS node, to MF2/DF2 and forwarded 28 from MF2/DF2 to the LEMF where it can be fetched by the agency.
A request for new identities is demanded 29 by the agency, for example after analyzing the IRI.
A request 30 for future known identities is sent from the Law Enforcement Monitoring Facility LEMF to the Administration Function ADMF on the interface HI4. The LEMF requires the user-centric identities by sending the known target identity MSISDN as key to find federated identities related to the target.
The request is forwarded 31 from the ADMF to the Identity Management Controller IMC on the interface X4.
A new service subscription related to the target T is detected by the MMS node. The new service is an MMS service subscribed with the identity nickname@mms_NWO_domain.
The identity nickname@mms_NWO_domain related to the target MSISDN is collected by IdMan from the NetWork Operator NWO and stored in the IdDB.
A notification comprising the new identity federated to MSISDN is sent 32 from IMC to ADMF on X4. The agency is notified 33 of the new subscription when the computer C receives the forwarded notification from ADMF on HI4.
In this embodiment, the agency decides to take no measures and no interception related to the new found identity will consequently be required by the agency.

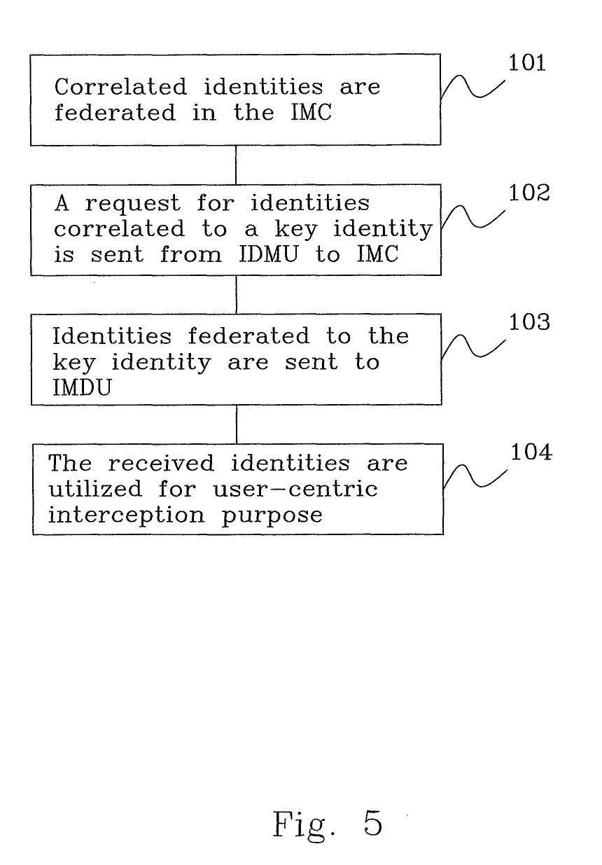

FIG. 5 discloses a flow chart illustrating some essential method steps of the invention. The flow chart is to be read together with the earlier shown figures. The flow chart comprises the following steps:
Correlated identities are federated in the Identity Management Controller. This step is shown in the figure with a block 101.
A request for identities correlated to a specified key target identity is sent from an Intercept Unit to the Identity Management Controller. This step is shown in the figure with a block 102.
The identities federated to the specified key target identity are received to the Intercept Unit. This step is shown in the figure with a block 103.
The received identities are utilized for user-centric interception purposes. This step is shown in the figure with a block 104.

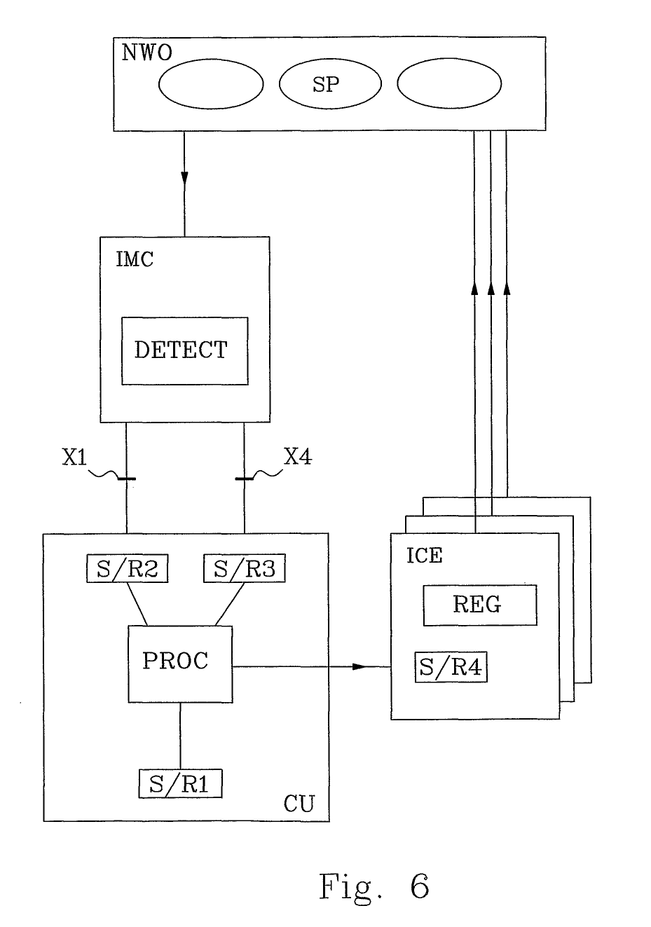

A system that can be used to put the invention into practice is schematically shown in FIG. 6. The block schematic constellation corresponds in many parts to the one disclosed in FIG. 2 and comprises a Central Unit CU having a processor PROC that via a send/receive element S/R1 receives control commands, e.g. from an agency. The processor is capable to handle control commands and generate requests for identities. The requests are sent via send/receive elements S/R2 or S/R3 and interfaces X1 and X4 to an IMC. The IMC comprises a detector, capable to detect identities federated to a key identity received from the CU, and to forward the federated identities via the interfaces X1 or X4 and the send/receive elements S/R2 or S/R3 to the CU where they are handled by PROC. The processor can activate interception subsequent the handling of the federated identities and send interception activations via a send/receive element S/R4 to an Intercept Control Element ICE and to receive IRI and CC from the ICE. In FIG. 6 can also schematically be seen how subscriptions can be provisioned to Service Providers SPs from one or more ICEs and that the IMC is capable to collect identities from the SPs.

Enumerated items are shown in the figure as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is of course not limited to the above described and in the drawings shown embodiments but can be modified within the scope of the enclosed claims.

1. A method for user-centric interception in a telecommunication system wherein correlated identities are federated in a user centric node, comprising the following steps:
sending from an Intercept Unit to the centric node, a request for identities correlated with a specified key target identity;
receiving at the Intercept Unit, all available federated identities correlated to the specified key target identity; and
utilizing the received identities for user-centric interception purposes.

2. The method for user-centric interception according to claim 1, comprising the following further steps:
further requesting new identities when new subscriptions for the specified target is recognized by the centric node;
detecting in the centric node a new subscription for the specified target identity; and
receiving at the Intercept Unit a new identity related to the new subscription from the centric node.

3. The method for user-centric interception according to claim 1, comprising the following further step:
activating interception linked to at least one of the received identities.

4. The method for user-centric interception according to claim 3, comprising the following further steps:
receiving at an Intercepting Control Element linked to one identity of the received identities, a request to monitor the identity;
registering, in the Intercepting Control Element, an activity involving the monitored identity; and
delivering information related to the activity, from the Intercepting Control Element to the Intercept Unit.

5. The method for user-centric interception according to claim 1 wherein the centric node federates identity according to OASIS SAML 2.0.

6. The method for user-centric interception according to claim 1 wherein subscriptions are received by the centric node from service nodes.

7. The method for user-centric interception according to claim 6 wherein subscriptions are received by the centric node at the provision phase of the service nodes.

8. An apparatus for user-centric interception in a telecommunication system comprising a user centric node wherein correlated identities are federated, comprising:
means for sending a request for identities correlated to a specified target identity, from an Intercept Unit to the centric node;
means for receiving the requested identities at the Intercept Unit; and
means to utilize the received identities for user-centric interception purposes.

9. The apparatus for user-centric interception according to claim 8, comprising:
means to further request new identities when new subscriptions for the specified target is recognized by the centric node;
means to detect in the centric node a new subscription for the specified target identity; and
means to receive a new identity related to the new subscription from the centric node to the Intercept Unit.

10. The apparatus for user-centric interception according to claim 8, comprising:
means to activate interception linked to at least one of the received identities.

11. The apparatus for user-centric interception according to claim 10, comprising:
means to receive at an Intercepting Control Element linked to one identity of the received identities, a request to monitor the identity;
means to register in the Intercepting Control Element, an activity involving the monitored identity; and
means to deliver information related to the activity, from the Intercepting Control Element to the Intercept Unit.

12. The apparatus for user-centric interception according to claim 8 comprising means to receive subscriptions to the centric node from service nodes.

13. The apparatus for user-centric interception according to claim 8 comprising at least one two-way communication interface between the intercept unit and the centric node.

14. A monitoring node for user-centric interception in a telecommunication system, comprising:
means in the monitoring node to send a request for identities correlated to a specified key target identity, from an Intercept Unit to a user centric node;
means in the monitoring node to receive the requested identities; and
means in the monitoring node to utilize the received identities for user-centric interception purposes.

15. A user centric node for user-centric interception in a telecommunication system, comprising:
means in the node to receive a request for identities correlated to a specified key target identity, from an Intercept Unit;
means in the node to federate identities correlated with the key identity; and
means in the node to send requested identities to the intercept unit.

16. An article for manufacture comprising a program storage medium having computer readable program code embodied therein for providing information related to user-centric interception in a telecommunication system comprising a user centric node wherein correlated identities are federated, the computer readable program code in the article of manufacture comprising:
computer readable program code for sending a request for identities correlated to a specified target identity, from an Intercept Unit to the user centric node;
computer readable program code for receiving the requested identities at the Intercept Unit; and
computer readable program code to utilize the received identities for user-centric interception purposes.

17. An article for manufacture comprising a program storage medium having computer readable program code embodied therein for providing information related to user-centric interception in a telecommunication system, comprising:
computer readable program code to send a request for identities correlated to a specified key target identity, from an Intercept Unit to a user centric node wherein correlated identities are federated;
computer readable program code to receive the requested identities; and
computer readable program code to utilize the received identities for user-centric interception purposes.

18. An article for manufacture comprising a program storage medium having computer readable program code embodied therein for providing information related to user-centric interception in a telecommunication system, comprising:
computer readable program code to receive a request for identities correlated to a specified key target identity, from an Intercept Unit;
computer readable program code to federate identities correlated with the key identity; and
computer readable program code to send requested identities to the intercept unit.
